(19) United States
(12) Patent Application Publication
(10) Pub. No.: US 2026/0145621 A1
(43) Pub. Date: May 28, 2026

(54) CARGO AREA PULL-OUT TRAY ASSEMBLY

(71) Applicant: Bedsled...For Trucks, LLC, Westlake, OH (US)

(72) Inventor: Keith Loughner, Toledo, OH (US)

(21) Appl. No.: 19/397,510

(22) Filed: Nov. 21, 2025

Related U.S. Application Data
(60) Provisional application No. 63/724,108, filed on Nov. 22, 2024.

(51) Int. Cl. B60R 9/06

(52) U.S. Cl. CPC B60R 9/06

(57) ABSTRACT

A vehicle cargo area pull-out tray assembly for easily accessing a cargo area of a vehicle. The assembly includes a base, bearings, and a tray. The base is removably connected to sides of the cargo area. The bearings are arranged on top of the base between the base and the tray. Each of the bearings is a unitary, single-piece of low-friction material. The tray can hold cargo and is arranged on the bearings. The tray and is movably connected to the base between a stored position totally within the cargo area of a vehicle, and an extended position extending out of the cargo area for easy access of the cargo from a back of the vehicle. The tray moves in and out via sliding pins that extend from each side of the tray through closed sliding slots in the base.

### CROSS REFERENCE TO RELATED APPLICATION

This application claims priority to U.S. Provisional Patent Application Ser. No. 63/724,108 filed Nov. 22, 2024, which is expressly incorporated herein by reference.

### BACKGROUND

Typical trucks, SUVs, vans and other large vehicles can have spaces specifically dedicated to holding and transporting cargo. These cargo areas may be accessed from a tailgate or rear door of the vehicle and may be quite large and extend a significant distance toward the front of the vehicle. Because of their size and height off the ground, large portions of these cargo areas may be difficult for a user to easily reach by hand from the back of the vehicle. Therefore, in order to deposit and access cargo in these hard-to-reach portions of the cargo area, a user may be required to either bend over and stretch and reach inside the cargo area, or fully enter into the cargo area, both of which can be inconvenient.

### SUMMARY

A vehicle cargo area pull-out tray assembly includes a base, bearings, and a tray. The base includes a bottom base wall, two side base walls, a back base wall, an open base front, and an open base top. The bearings are arranged on a top surface of the bottom wall of the base. Each of the bearings consists of a unitary, single-piece material. The tray is arranged on the bearings and is movably connected to the base between a stored position and an extended position.

### BRIEF DESCRIPTION OF THE DRAWINGS

FIG. 1 is a schematic top view of a tray assembly secured in a cargo area of a vehicle according to the present subject matter.

FIG. 2 is a perspective view of tray assembly in a stored position according to the present subject matter.

FIG. 2 is a perspective view of the tray assembly in an extended position according to the present subject matter.

FIG. 4 is a detailed perspective view of a back corner of a tray according to the present subject matter.

FIG. 5 is a detailed perspective view of an anchor plate according to the present subject matter.

FIG. 6 is a detailed perspective view of a back corner of a base according to the present subject matter.

FIG. 7 is schematic side view of an anchor plate and locking rod in a locked engagement according to the present subject matter.

FIG. 8 is a perspective view of a two-part tray in a disconnected state according to the present subject matter.

FIG. 9 is a perspective bottom view of one half of a two-part tray according to the present subject matter.

FIG. 10 is a perspective view of a tray assembly partially inserted in a cargo area of a vehicle according to the present subject matter.

### DETAILED DESCRIPTION

The present subject matter relates to a pull-out tray assembly that can be arranged in the cargo area of a truck, SUV, van or other vehicle for making it easy to access hard-to-reach portions of the cargo area for depositing and retrieving cargo therein. Cargo may be placed on the tray assembly, and the assembly may be used to easily insert the cargo into the cargo area and later retrieve the cargo from the cargo area, all without having to bend over, stretch, reach or fully enter into the cargo area.

In a truck, for example, when a tailgate of the truck is down, a user may simply pull out a tray of the assembly from the truck bed (cargo area) so the tray is closer to the user, and then deposit/retrieve the cargo on/from the tray. The tray, when pulled out from the truck bed, may be arranged over the tailgate for easy access by a user.

With reference to the figures, the tray assembly 2 (sometimes referred to herein as “assembly 2”) may be arranged in a cargo area 4 of a vehicle 6, for example, the bed (cargo area 4) of a pickup truck (vehicle 6). The tray assembly 2 includes a base 8 and a tray 10 that is movable relative to the base 8 so as to slide towards a rear of the vehicle 6 for easy access by a user that is positioned at a rear 12 of the vehicle 8.

### Base

The base 8 is the stationary portion of the assembly 2 and secures the assembly to the vehicle 6. The base 8 has a general box shape with an open base top and open base front, and including a bottom base wall 18, two side base walls 20, 22, and a back base wall 24. The bottom base wall 18 of the base 8 may be a solid surface (as shown) or may include one or more cutouts therein to reduce weight and material usage. The base 8 may include one or more apertures through which a fastener is inserted for securing the base 8 to the cargo area 4, either to the floor panel 14 or the sides 16 of the cargo area 4.

The two side base walls 20, 22 each include a closed sliding slot 26 extending along its length and forming a sliding guide for the tray 10 as explained in more detail herein. The back base wall 24 may act as a stop that inhibits backward movement of the tray 10 relative to the base 8, and otherwise may provide, along with the side base walls 20, 22, rigidity to the base 8.

The base 8 also includes one or more bearings 28 arranged on and secured to the top surface of the bottom base wall 18, and which are included to bear the weight of the tray 10 and anything (e.g. cargo) resting on the tray 10. The bearings 28 inhibit the bottom surface of the tray 10 from contacting the upper surface of the base 8 and decrease friction between the base 8 and the tray 10 when the tray 10 is urged to move relative to the base 8 and the bearings 28.

The bearings 28 may be made of any low-friction material that reduces friction between the base 8 and the tray 10, including but not limited to PET, PTFE, POM, nylon, polyamide, PEEK, PPS, acetal, polyester, UHMW PE, HPV, PET-P, Derlin® or combinations thereof, or composites of these with other materials.

The bearings 28 may each be a single-piece, unitary, solid material with no moving parts, which design is simple, robust, inexpensive, and space saving. The bearings 28 may have a smooth or a textured upper surface that contacts the bottom surface of the tray 10. The bearings 28 may be secured to the base 8 by any means, including for example, adhesive, fasteners, or by lamination. The bearings 28 may cover the entire upper surface of the base 8 or may cover only a portion of the upper surface of the base 8. The bearings 28 may run a partial distance or the full distance between the front and back of the base 8.

As shown, the assembly includes four bearings 28 arranged on the upper surface of the base 8 and running lengthwise between the front and back of the base 8. More or less bearings 28 can be used. Two of the bearing 28 are arranged near the side base walls 20, 22, and the other two bearing 28 are arranged closer to the centerline of the base 8 between the other two bearings 28.

Alternatively, the entire base 8 (and optionally the entire tray 10) may be made of a low-friction material, and thus the use of separate bearings 28 may not be necessary. Where the entire base 8 is made of low-friction material, the base 8 may include ridges extending up from the rest of the base 8 that act as contact areas between the base 8 and the tray 10. The ridges may be sized and arranged in areas similar to the positioning of the bearings 28 as depicted on the base 8 in the figures.

The thickness of the bearings 28 is not particularly limited and this dimension determines the vertical separation between the base 8 and the tray 10. In embodiments where the bearings 28 are of a unitary, solid, one-piece low-friction material, the bearings 28 can be made relatively thin, and thus save on the vertical space occupied by the assembly 2, thus saving room for cargo to be placed on top of the tray 10, for example, underneath a truck bed cover (e.g. tonneau cover) or inside an SUV or van. In contrast, the use of bearings with multiple moving parts such as ball bearings, as is conventional, typically takes up more vertical space because of the size of the ball bearing mechanism, thus reducing the available vertical space for cargo on top of the tray 10 and underneath the truck bed cover. Moreover, such ball bearings are typically constructed from metal, thus making conventional bearing systems heavier than the bearings 28.

The base 8 may be a single, unitary piece of material (e.g. metal, plastic, composite, or other material) or it may be assembled from multiple individual pieces of material as described in more detail herein. The material defines the bottom base wall 18 and may be bent upwards on two sides and the back to form the side base walls 20, 22 and back base wall 24.

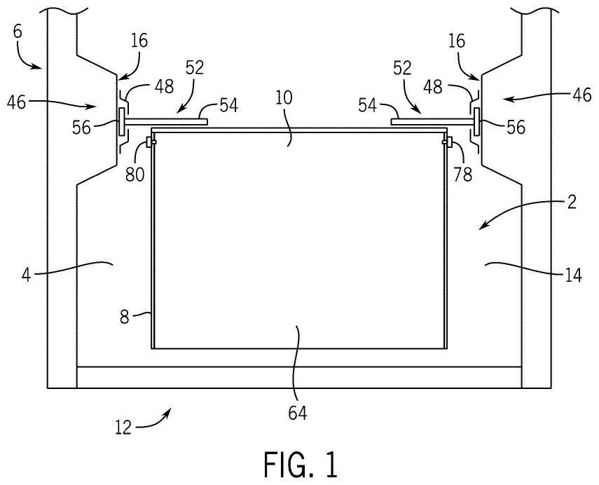

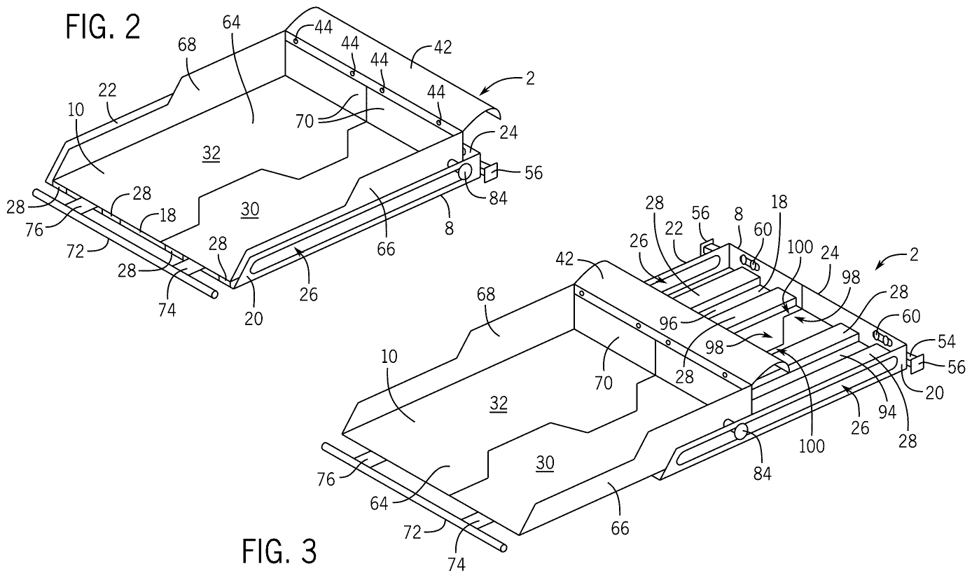

The base 8 is secured in a fixed position relative to the cargo area 4 to remain stationary with respect to the cargo area 4 during use of the assembly 2 and movement of the tray 10 relative to the base 8 from a stored position (FIGS. 1 and 2) to an extended position (FIG. 3). The manner in which the base 8 is secured to the vehicle 6 and relative to the cargo area 4 is not particularly limited, and may include fixing the base 8 to a floor panel 14 of the cargo area 4 or to the sides 16 of the cargo area 4.

The base 8 may be secured to the vehicle 6 by any number of fasteners, which can include a screw and expanding anchor, where the anchor may be placed inside a hole drilled in a surface (e.g. a floor panel) of the cargo area 4, and the screw may be inserted through an aperture in the base 8 and into the anchor, thus expanding the anchor in the hole to create a friction fit therein, thereby securing the base 8 relative to the cargo area 4.

Other manners of connection may be used, including that as depicted in the figures, where the base 8 is secured to the sides 16 of the cargo area 4, which, for example, can be wheel wells in the cargo area 4 of the vehicle 6. As depicted, the assembly 2 includes a two-part quick-release anchoring system 46, which is used to secure each of the left and right sides of the back base wall 24 of the base 8 to the two sides 16 of the cargo area 4. The anchoring system 46 includes an anchor plate 48 including an open slot 50, and a locking rod 52 including a rod shaft 54 and rod head 56 at the end of the rod shaft 54.

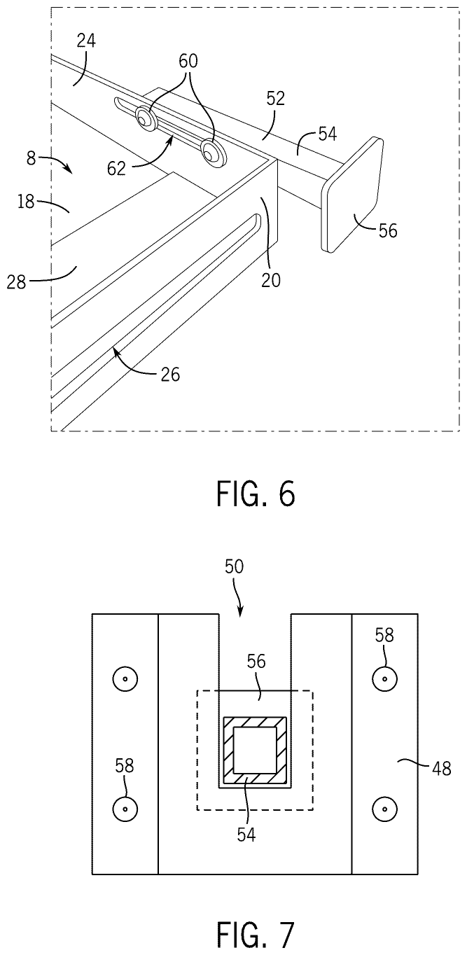

The rod shaft 54 is fixed to back base wall 24 of the base 8 such that the rod head 56 sticks out sideways past one of the side base walls 20, 22 as shown in FIGS. 1-3 and 6. The anchor plate 48 is configured to be secured to the corresponding side 16 (e.g. wheel well) of the cargo area 4 such that the open slot 50 in the anchor plate 48 opens in an upward direction as shown in FIGS. 5 and 7.

To secure the base 8 relative to the cargo area 4, the rod shaft 54 is placed in the open slot 50 of the anchor plate 48 (FIG. 7) while the rod head 56 is arranged between the anchor plate 48 and the side 16 of the cargo area 4, i.e. the rod head 56 is arranged on a side of the anchor plate 48 opposite from the base 8 (FIG. 1). Gravity moves the rod shaft 54 toward the bottom of the open slot 50 (FIG. 7), whereby the rod head 56 is secured between the anchor plate 48 and the side 16 of the cargo area 4. The same process is done on the other side of the base 8 and cargo area 4, thereby securing the base 8 relative to the cargo area 4.

To unsecure the base 8 relative to the cargo area 4, e.g. to move or remove the base 8 or the entire assembly 2 from the cargo area 4, the locking rod 52 can be easily and quickly lifted up and removed from the open slot 50, thus freeing the rod head 56 from being secured between the anchor plate 48 and the side 16 of the cargo area 4. This allows free movement of the base 8 relative to the cargo area.

The anchor plate 48 may be fixed only to the sides 16 of the cargo area 4 by plate fasteners 58, where four or more or less plate fasteners 58 can be used, and such plate fasteners 58 can be self-piercing. Arranging the anchor plate 48 on the side 16 of the cargo area 4 keeps the anchor plates off the floor panel 14. This arrangement may allow a user to freely put material (e.g. dirt, gravel, mulch) on the floor panel 14 when the tray assembly 2 is not arranged in the vehicle 6 by inhibiting the material from contaminating the anchor plate 48 and inhibiting its use, and by keeping the anchor plate out of the way of the material to allow the material to be easily removed from the cargo area 4, e.g. by a shovel or other tool.

The rod shaft 54 is fixed to the back base wall 24 of the base 8 by shaft fasteners 60 inserted through the closed locking slots 62 and connected to the rod shaft 54, where two or more or less shaft fasteners 60 can be used. The shaft fasteners 60 are inserted through closed locking slots 62 in the back base wall 24 of the base 8 and secured into the rod shaft 54. Such closed locking slots 62 allow for positioning of the shaft fasteners 60 at different positions along the length of the closed locking slots 62, and thus allowing position of the locking rod 52 at different lateral positions relative to the base 8, thereby allowing the rod head 56 of the locking rod 52 to stick out width-wise more or less from the base 8 as desired and thereby allowing the base 8 to be connected to the sides of cargo areas having different widths different types of vehicles 6. A lateral position of the locking rod 52 relative to the base 8 is adjusted by securing the shaft fasteners 60 at a desired position along a length of the closed locking slots 62.

### Tray

The tray 10 is arranged on the bearings 28 and is movably (slidably) connected to the base 8, where the tray 10 slides relative to the base 8 over the bearings 28 between the stored position (FIG. 2) and the extended position (FIG. 3). The tray 10 may be of a one-piece construction or multi-piece construction. The tray 10, similar to the base 8, has a box shape with an open tray top and open tray front, bottom wall 64, two side tray walls 66, 68 and a back tray wall 70. The side tray walls 66, 68 and back tray wall 70 may be of a one-piece construction with the bottom tray wall 64 of the tray 10.

The back tray wall 70 may include or have connected thereto a shelf 42 extending from a top of the back tray wall 70 in a direction away from the open tray front and over the back base wall 24 when the assembly 2 is in the stored position (FIGS. 2-4). The shelf 42 may inhibit cargo placed on the tray 10 from falling off the tray 10 over the back tray wall 70 and into the cargo area 4 or into the base 8, which could prevent the tray 10 from moving to the stored position. The shelf 42, if a separate piece of material from the tray 10, may be connected thereto by the shelf fasteners 44. Either the back tray wall 70 or the shelf 42 (if a separate piece of material from the back wall 70) may include an extension 88 for connecting to the side tray walls 66, 68 with tray fasteners 90 to make the tray 10 more rigid.

The tray 10 may be slightly smaller than the base 8 and thus sits inside the base 8 (See FIGS. 1-3) such that the side walls tray walls 66, 68 and back tray wall 70 of the tray 10 are arranged inside the side base walls 20, 22 and back base wall 24 of the base 8 with only a small space between them.

The tray 10 may include a handle 72 for a user to move (slide) the tray 10 relative to the base 8 with the weight of the tray 10 and any cargo thereon being borne by the bearings 28. The handle 72 may be permanently or removably secured to the tray 10 by various means, which are not particularly limited. In one non-limiting embodiment, the handle 72 is secured to the base 8 via tabs 74, 76 extending up at the front of the tray 10 and forward from the bottom wall 64 to the handle 72. The tabs 74, 76 may be of an integral, one-piece construction with the base 8. The handle 72 may extend a partial or full distance between the two side tray walls 66, 68 of the tray 10.

The tray 10 may include two sliding pins 78, 80 removably connected to tray 10 and slidably connected with the closed sliding slots 26 in the two side base walls 20, 22 of the base 8. The pins 78, 80 removably connect the tray 10 to the base 8, where disconnecting the pins 78, 80 form the tray 10 allows the tray 10 to be disconnected from the base 8. The pins 78, 80 also movably (slidably) connect the tray 10 to the base 8 by allowing the tray 10 to slide relative to the base 8 between the stored position and the extended position, wherein the pins 78, 80 slide within and along the length of the sliding slots 26.

When the tray 10 is in the stored position, the sliding pins 78, 80 may be close to or contact the back of the closed sliding slots 26 near the back base wall 24. When the tray 10 is in the open position, the sliding pins 78, 80 may be close to or contact the front of the closed sliding slots 26 near the open front of the base 8 opposite from the back base wall 24.

The sliding pins 78, 80 project laterally out from respective side tray walls 66, 68 of the tray 10. The sliding pins 78, 80 are arranged near a back and bottom of each respective side tray wall 66, 68 near the back tray wall 70 of the tray 10. The sliding pins 78, 80 are inserted through and secured to the respective closed sliding slots 26 in the side base walls 20, 22 of the base 8. When the tray 10 is pulled out or pushed in from the cargo area 4 by being moved between the stored position and extended position, the sliding pins 78, 80 slide forward and backward in their respective closed sliding slot 26.

The sliding pins 78, 80 may include a pin shaft 82 extending through the closed sliding slots 26, and a pin head 84 arranged on a side of the closed sliding slot 26 opposite from the tray 10. The pin head 84 is wider than the pin shaft 82 and is wider than the height of the closed sliding slots 26 and arranged laterally outward thereof so as to inhibit removal of the sliding pins 78, 80 from the closed sliding slots 26. The sliding pins 78, 80 may each be removably connected to the tray 10 by a fastener (e.g. a nut), where removal of the sliding pins 78, 80 from the tray 10 disconnects the tray 10 from the base 8. This allows for easy installation and removal of the pins 78, 80 from the tray 10 and thus easy detachment of the tray 10 from the base 8. The sliding pins 78, 80 are slidingly connected to the closed sliding slots 26 such that the sliding pins 78, 80 can slide along a length of the closed sliding slots 26 and the tray 10 can slide relative to the base 8 between a stored position and an extended position. The tray 10 may be connected to the base 8 only by the sliding pins 78, 80 being slidingly connected to the closed sliding slots 26.

The sliding pins 78, 80 act to guide the forward and backward sliding movement of the tray 10 relative to the base 8 between the stored position and extended position and to keep the tray 10 slidingly connected to the base 8. The sliding connection between the closed sliding slots 26 and sliding pins 78, 80 may limit how far the tray 10 can slide forward and backward relative to the base 8. As the tray 10 is moved forward and backward relative to the base 8, the pin shaft 82 of each of the sliding pins 78, 80 slides along each corresponding closed sliding slot 26. Meanwhile, the bottom surface of the tray 10 slides along the top of the bearings 28. The extent of travel of the tray 10 with respect to the base 8 may be limited by the movement of the sliding pins 78, 80 within the closed sliding slots 26 and their abutment with the closed ends of the closed sliding slots 26. Thus, a user can pull out the tray 10 from the cargo area 4 from the stored position to the extended position in order to access the tray 10 and deposit or retrieve cargo on/from the tray 10, which is easier than depositing or retrieving cargo directly on/from the cargo area 4 without use of the tray assembly 2 since this retrieval without the use of the tray assembly 2 would require the user to bend over and reach into the cargo area 4 (and maybe over a tailgate of a pickup truck) and reach inside the cargo area 4 for such depositing and retrieving of cargo.

The bottom wall 64 of the tray 10 may include a textured upper surface to inhibit movement of cargo during transportation in the vehicle 6. This textured upper surface may be formed directly into the upper surface of the bottom wall 64 of the tray 10, or it may be formed by a textured insert, e.g. a rubber/plastic sheet, being placed over the bottom wall 64 of the tray 10.

The tray 10 may also include a removable covering (e.g. a net) for securing cargo on the tray 10 to inhibit its movement relative to the tray 10 when the vehicle 6 is being driven. The covering may be elastic and removably secured to the tray 10 by hooks connected to holes 92 in the side walls and/or back wall of the tray 10.

The tray 10 may be a single, unitary piece of material (e.g. metal, plastic, composite, or other material), or it may be assembled from multiple individual pieces of material as described in more detail herein. The material defines the bottom wall 64, and the material of the bottom wall 64 may be bent upwards on two sides and the back to form the side tray walls 66, 68 and back tray wall 70.

### Two-Piece Construction

In a non-limiting embodiment, the tray 10 includes a first tray piece 32 and a second tray piece 32, each including one respective side tray wall 66, 68 and half the back tray wall 70, and which connect with each other to from the tray 10. The first and second tray pieces 30, 32 each include a series of tray fingers 34 and tray grooves 36 that mate with the corresponding tray fingers 34 and tray grooves 36 on the other tray piece to permanently or removably connect the two tray pieces 30, 32 together to form the tray 10. Hereafter the first and second tray pieces 30, 32 are described as being removably connected to each other, but it should be understood that such connection may instead be a permanent connection.

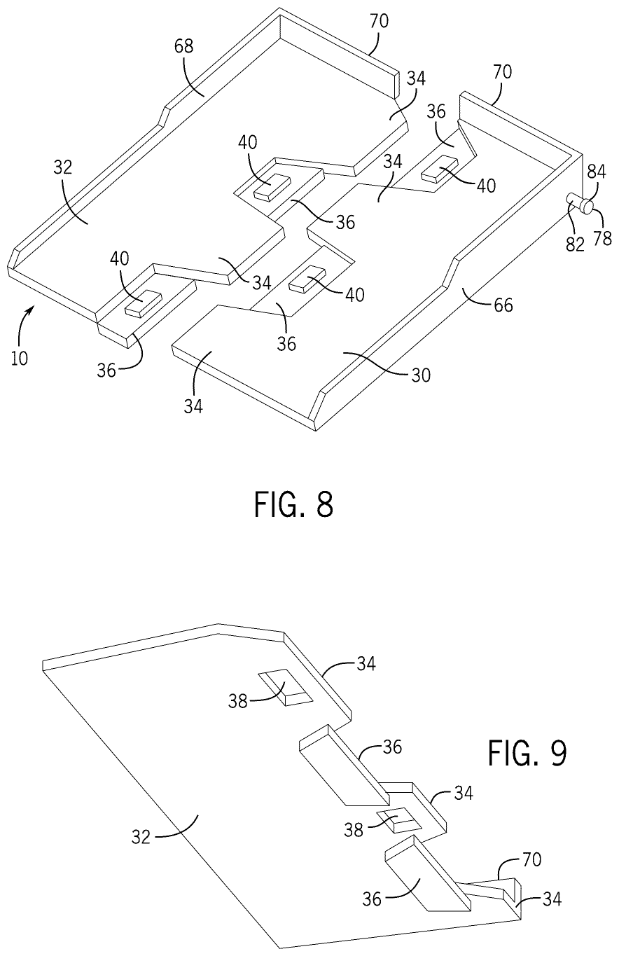

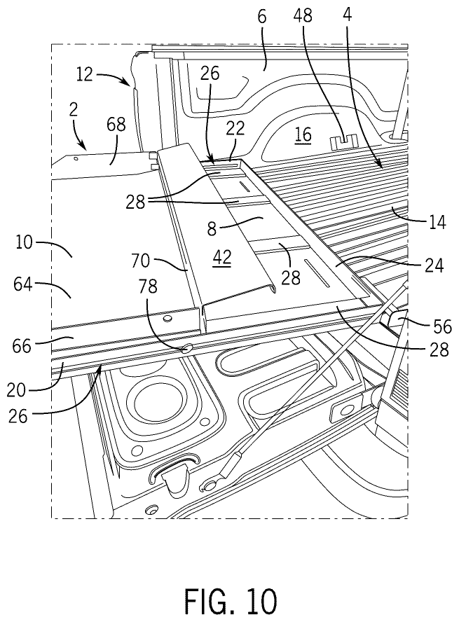

Each tray groove 36 may include a projection 40 (see FIG. 8) on its top surface. When a tray groove 36 is mated to a corresponding tray finger 34, the projection 40 mates and removably connects with a correspondingly shaped and sized depression 38 (see FIG. 9) by fitting inside the depression 38 on the bottom surface of the corresponding tray finger 34. This mating and connection of the tray fingers 34 and their depressions 38 with the corresponding tray grooves 36 and their extensions 40 act to removably connect the two tray pieces 30, 32 together to form the tray 10. FIG. 9 shows the bottom of the first tray piece 30, and it should be understood that the bottom of the second tray piece 32 has similar and corresponding features for their mating and removably conneting together.

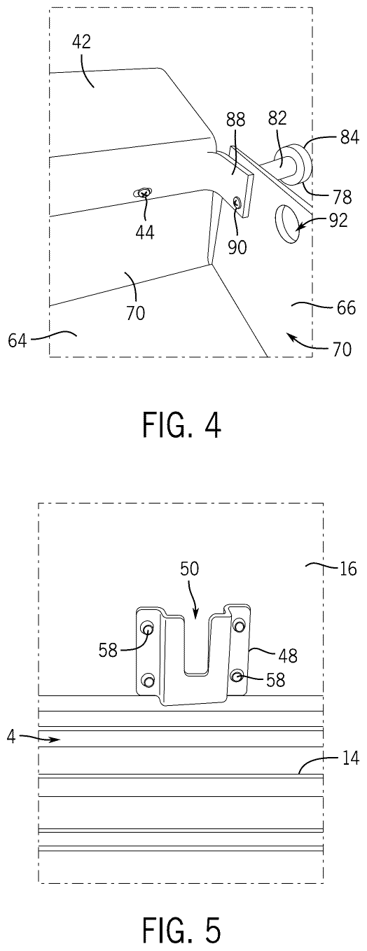

The connection of the two tray pieces 30, 32 together to form the tray 10 may be strengthened by connecting the shelf 42 to both tray pieces 30, 32 along the back of the tray 10, where the shelf 42 is connected to the tray 10 at the top of the back tray wall 70 (FIG. 4) with shelf fastners 44. The shelf 42 may extend the entire width of the tray 10 and connect to each of the tray pieces 30, 32 by one or more shelf fasteners 44 (e.g. two or more). The shelf 42 may include the extensions 88 on each of its lateral sides, each of which is connected to the corresponding side tray walls 66, 68 by a tray fastener 90 to further secure the side tray walls 66, 68, the shelf 42 and the back tray wall 70 relative to each other.

In a non-limiting embodiment, the base 8 may have a similar two-part construction as described herein for the tray 10, where the base 8 may include a first base piece 94 forming a portion of the bottom base wall 18 and a second base piece 96 forming a remaining portion of the bottom base wall 18. The first base piece 94 includes one side wall 20 of the two side base walls and a portion of the back base wall 24, and the second base piece 96 includes a second side wall 22 of the two side base walls and a remaining portion of the back base wall 24.

The first and second base pieces 94, 96 may be permanently or removably connected together and interconnect with each other to from the base 8 is a manner similar to or the same as the two-part tray 10. Hereafter the first and second base pieces 94, 96 are described as being removably connected to each other, but it should be understood that such connection may instead be a permanent connection.

The first and second base pieces 94, 96 each include a series of base fingers 98 and base grooves 100 that mate with the corresponding base fingers 98 and base grooves 100 on the other base piece to removably connect the two base pieces 94, 96 together to form the base 8.

Each base groove 100 may include a projection on its top surface that is the same as the projection 40 included on the first and second tray pieces 30, 32, and each base finger 98 may include a depression on its bottom surface that is the same as the depression 38 included on the first and second tray pieces 30, 32. When the base groove 100 is mated to a corresponding base finger 98, the projection mates and removably connects with a correspondingly shaped and sized depression of the corresponding base finger 98 by fitting side such depression. This mating and connection of the base fingers 98 and their depressions 38 with the corresponding base grooves 100 and their projections 40 act to removably secure the two base pieces 94, 98 together to form the base 8. The removably connecting of the two base pieces 94, 96 together to form the base 8 may be strengthened by inserting fasteners through a mated base finger 98 and base groove 100. FIG. 9 shows the bottom of the first base piece 94, and it should be understood that the bottom of the second base piece 96 has similar and corresponding features for their mating and removably connecting together.

The fingers and grooves of the first and second tray pieces 30, 32 and of the first and second base pieces 94, 96 do not require the projections and depressions as described herein, and the fingers and grooves may instead be devoid of such projections and depressions. The first and second tray pieces 30, 32 and the first and second base pieces 94, 96 can be removably connected together using the fingers and grooves as described herein or can be permanently connected together using the fingers and grooves. Additionally, the first and second tray pieces 30, 32 and the first and second base pieces 94, 96 can be removably or permanently connected together using different mating methods other than the fingers and grooves as described herein.

The two-part base 8 and two-part tray 10 may allow for easier and cheaper transport and storage of the assembly 2 because they take up less space than a one-piece base 8 and one-piece tray 10.

Many other benefits will no doubt become apparent from future application and development of this technology.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scopes of the claimed subject matter, as expressed in the appended claims.

It will be appreciated that various of the above-disclosed embodiments and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle cargo area pull-out tray assembly including:
a base including a bottom base wall, two side base walls, a back base wall, an open base front, and an open base top;
bearings arranged on a top surface of the bottom base wall, wherein each of the bearings consists of a unitary, single-piece material; and
a tray arranged on the bearings and movably connected to the base between a stored position and an extended position.

2. The tray assembly of claim 1, further including an anchoring system configured to anchor the base only to a side of a vehicle cargo area.

3. The tray assembly of claim 2, wherein the anchoring system includes:
a locking rod including a rod shaft connected to the back base wall and a rod head at an end of the rod shaft; and
an anchor plate configured to connect to the side of the vehicle cargo area, including an open slot, and mating with the locking rod such that the rod shaft is arranged within the open slot of the anchor plate and the rod head is arranged on a side of the anchor plate opposite from the base.

4. The tray assembly of claim 3, wherein:
the back base wall includes a closed locking slot;
the rod shaft is adjustably connected to the base via a shaft fastener inserted through the closed locking slot and connected to the rod shaft; and
a lateral position of the locking rod relative to the base is adjusted by securing the shaft fastener at a desired position along a length of the closed locking slot.

5. The tray assembly of claim 1, wherein:
the base includes a closed sliding slot in each of the side base walls;
the tray includes a bottom tray wall, two side tray walls, a back tray wall, open tray front, open tray top, and a sliding pin projecting from each of the two side tray walls; and
the sliding pin is slidingly connected to the closed sliding slot such that the sliding pin can slide along a length of the closed sliding slot and the tray can slide relative to the base between a stored position and an extended position.

6. The tray assembly of claim 5, wherein the sliding pin includes:
a pin shaft extending through the closed sliding slot; and
a pin head arranged on a side of the closed sliding slot opposite from the tray.

7. The tray assembly of claim 5, wherein the tray is connected to the base only by the sliding pin being slidingly connected to the closed sliding slot.

8. The tray assembly of claim 5, wherein:
the sliding pin is removably connected to tray; and
removal of the sliding pin from the tray disconnects the tray from the base.

9. The tray assembly of claim 1, wherein:
the base includes a first base piece comprising a portion of the bottom base wall and a second base piece comprising a remaining portion of the bottom base wall; and
the first base piece is removably connected to the second base piece.

10. The tray assembly of claim 9, wherein:
the first base piece and the second base piece each include base fingers and base grooves; and
the base fingers of the first base piece mate with the base grooves of the second base piece and the base fingers of the second base piece mate with the base grooves of the first base piece to thereby removably connect the first base piece to second base piece.

11. The tray assembly of claim 10, wherein:
each base finger includes a depression on its bottom surface;
each base groove includes a projection on its top surface; and
the depression fits inside the projection when the first base piece is removably connected to the second base piece.

12. The tray assembly of claim 9, wherein:
the first base piece includes one of the two side base walls and a portion of the back base wall; and
the second base piece includes a second of the two side base walls and a remaining portion of the back base wall.

13. The tray assembly of claim 1, wherein:
the tray includes a first tray piece comprising a portion of the tray bottom wall and a second tray piece comprising a remaining portion of the tray bottom wall; and
the first tray piece is removably connected to the second tray piece.

14. The tray assembly of claim 13, wherein:
the first tray piece and the second tray piece each include tray fingers and tray grooves; and
the tray fingers of the first tray piece mate with the tray grooves of the second tray piece and the tray fingers of the second tray piece mate with the tray grooves of the first tray piece to thereby removably connect the first tray piece to second tray piece.

15. The tray assembly of claim 14, wherein:
each tray finger includes a depression on its bottom surface;
each tray groove includes a projection on its top surface; and
the depression fits inside the projection when the first tray piece is removably connected to the second tray piece.

16. The tray assembly of claim 13, wherein:
the first tray piece includes one of the two side tray walls and a portion of the back tray wall; and
the first tray piece includes a second of the two side tray walls and a remaining portion of the back tray wall.

17. The tray assembly of claim 13, further comprising a shelf extending along a width of the tray, connected to a top of the back tray wall by shelf fasteners, and extending out from the top of the back tray wall in a direction away from the open tray front.

18. The tray assembly of claim 13, further including a handle connected to the tray for moving the tray relative to the base.

19. The tray assembly of claim 18, wherein:
the first tray piece and the second tray piece each include an integral tab extending from a front of the bottom tray wall; and
the tab removably connects the handle to the tray.

20. A vehicle including the tray assembly of claim 1 arranged in a cargo area of the vehicle and removably connected to the sides of the cargo area.
